(19) United States
(12) Patent Application Publication
(10) Pub. No.: US 2006/0230656 A1
(43) Pub. Date: Oct. 19, 2006

(54) Artificial portable fireplace

(76) Inventor: Philipp Spengler, Kew Gardens, NY (US)

Correspondence Address: PHILIPP SPENGLER, 85-16 ABINGDON RD KEW GARDENS, NEW YORK, NY, 11415, US

(21) Appl. No.: 11/227,554

(22) Filed: Feb. 3, 2006

Related U.S. Application Data
(63) Continuation of application No. 09/655,707, filed on Sep. 6, 2000, now abandoned.
(60) Provisional application No. 60/152,349, filed on Sep. 7, 1999.

(51) Int. Cl. G09F 19/00

(52) U.S. Cl. 40/428

(57) ABSTRACT

This one unit product, (with its necessary accessories), a uniquely folding operatus, converts from one extreme, a three dimensional figure (comparable to a large suitcase), into the other extreme (a practical product), an electrically energized fireplace of virtual reality with all the facets of realism and enchantment, by the required simple described mechanical movement sequentially activated and utilizes a necessary accessory for easy installation.

### DETAILED DESCRIPTION OF THE PREFERRED EMBODIMENT

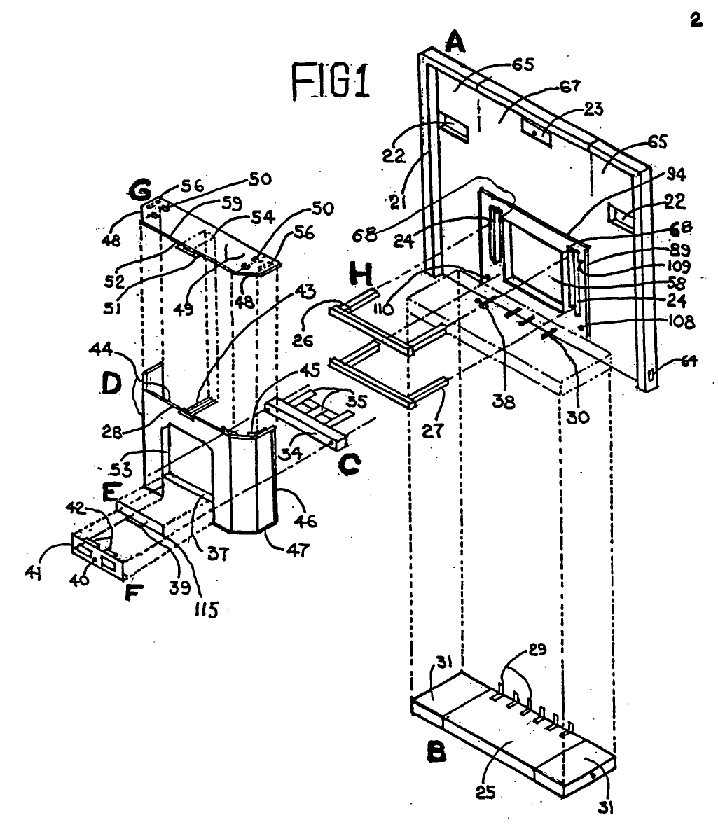

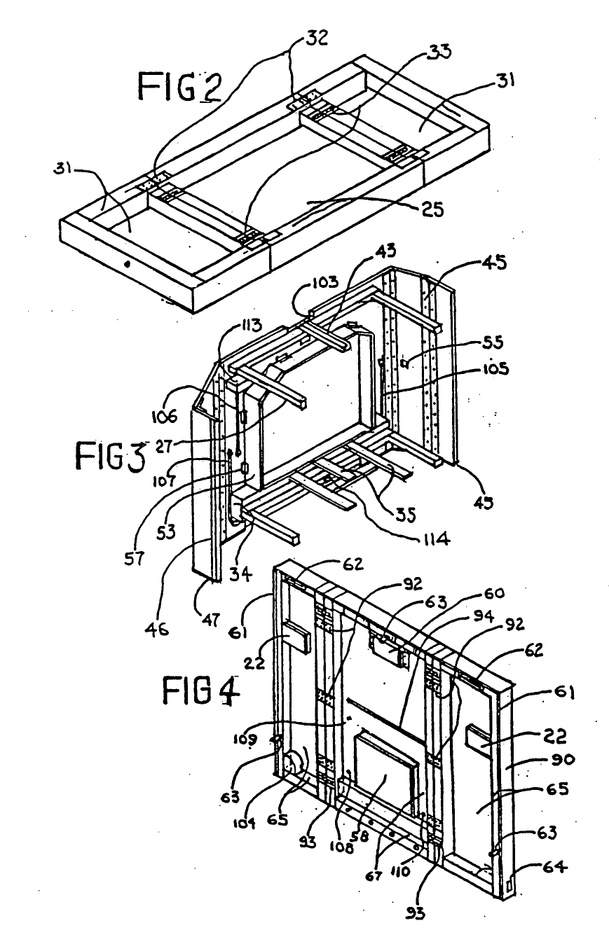

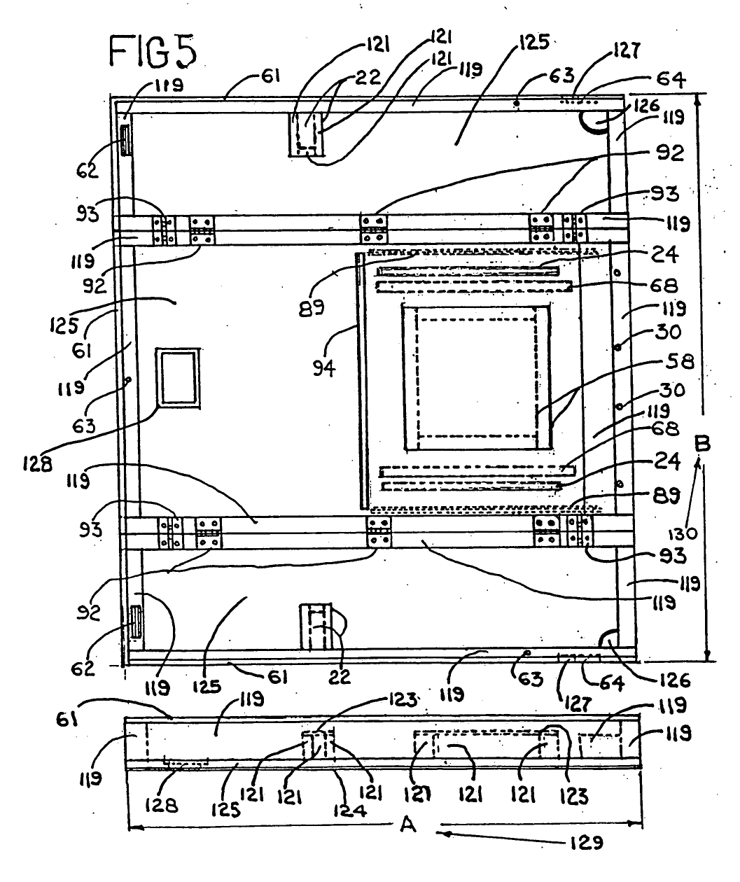

FIG. 1A is a sectional perspective curtailed in the composite of this decorative, artificial portable fireplace which is described in all of the pertaining documents herein: 20 constitute a lightweight strong and durable plastic mold. To conform with an appropriate desired décor and comprised of a self locking, 180° span allowance hinges in three places of each adjoining piece 65, left and right and 67 as seen in FIG. 4, followed suit by utilizing suitable size lock bolts 93 of FIG. 4 for reinforcing stability, comprising a wood appearance 21 of FIG. 1A, which is partially circumferencing the brick appearance decor referred to as the backing wall of the fireplace in FIG. 1A with left and right recesses 22 as defined in FIG. 1A, and are not to extrude beyond the rear outer surface of the backing wall of the fireplace perimeter 21 of FIG. 1A to be utilized for decorative purposes; to accommodate figures, etc. The ⅛″ thick aluminum control panel 23 pertains provision for five controls, including a provision for the optional utilization of a heat reflector if desired with two pertaining spring hinged, 1/16″ thick aluminum (cover panels covering the control panel) 23 a vertical oriented lightweight metal preferably aluminum slide 24, positioned securely and attached in the molding process as indicated in FIG. 1A, not to exceed the proper required extrusion from the artificial molded brick surface in FIG. 1A comprised of lock hinged sections 65 (left and right) and 67 referred to as the backing wall of the fireplace and not to exceed the required distance in conforming to ensure the function of the burn log cavity enclosure 44, to function as defined when unfolding adjust vertical slides 24 to conform centrally to the rittal construction bars assembly 26, joining in connecting using rittal dual bracket 27 in FIG. 1H attaching to FIG. 1C utilizing ft. hd. Bolts ¾″ long maximum penetrating ¼″ thick plywood wall with countersunk holes from the outside of the enclosure 44 as required to secure stability, prior to attaching outside 5/16″ thick furnier 28. Vertical slides 24 are to be oriented and positioned, to be of sufficient length to conform with the need to ensure apropriate clearance for the spring hinged 29 heavy fireplace base FIG. 1B, which is comprised of 31, left and right, joined to 25, utilizing 180° span lock hinges 32 in four places with stabilizing bolt lock 33 in four places to follow suit and is then attached centrally to FIG. 1A as defined. So when pulling upward by tension of spring hinges after being released by the four extruding bolts in FIG. 1A, will offer no interference to jeopardize the designated functions in the folding process. The essence on the performance of the three sectional 90° span locked hinged top cover 44 shown in FIG. 1G, comprised of section 48, left and right and mid-section 49, using lock hinges 50, in four places as defined in FIG. 2. Then appropriately attached one wing of hinge 54 centrally to the bottom surface of the assembled top cover, and utilize the other wing of hinge 54 and attach to the horizontal slide 43 as defined in FIG. 1D. A slotted recess 94 is centrally positioned on the molded backing wall of the fireplace as seen in FIG. 1A, providing a slide-in capacity of the top cover in the unfolding process. Henceforth when pulling the top cover out to the extreme, it utilizes the hinge 54 when bending 90° downward in the folding process providing an opening for the clocking bracket 102 extension in reference used for the clearance cutout 103 when unfolding and render itself parallel with the outer surface of the burn log cavity enclosure 44 of FIG. 1D in the folding process and eliminate any detachable light from the burn log unit 96 which is supported and mounted on the rack 35 while a triangular shaped obstruction 68 of suitable size, incorporated in the molding process situated on vertical parallel inner position in respect to the vertical slides 24 the length of the slides used to block the detection of vision of the vertical slides 24 when viewed from the opening of the burn log housing cavity 44. The ¼″-20 removable wing nuts 38 are utilized to tighten when aligning with slots provided on the fireplace base, shown in FIG. 1B and the extruding. The ¼″-20×6″ long bolts 30 of FIG. 1A activated by spring hinge attachments 29 between FIG. 1A and FIG. 2. A 2×4 wood cross section 31 with an ⅛″ thick aluminum 35 constructed of a 1¼″ size width and diversified pattern arrangement of various diameter-mounting holes not to exceed ¼″ diameter. Painted black, attached to the wooden cross section 34 with an ⅛″ thick aluminum 35 constructed of a 1¼″ size width and diversified pattern arrangement of various diameter-mounting holes not to exceed ¼″ diameter. Painted black, attached to the wooden cross section 34 as seen in FIG. 1C and assembled centrally to FIG. 1D internally mounted using two clearance mounting holes left and right countersunk externally, before furnier 28 is applied, using ¼″-20×1¾″ long steel hd. Bolts with washer and nut to tighten. Serves as the artificial burn log unit 96 supported by rack 35. Utilize #8×1″ long wood screws as required. Concentrate in maintaining a determinant size unit and orientation to ensure no interference with up and down slide action of the vertical slides 24 when in the process of folding and unfolding. The suitably patterned furnier 5/16″ strip 37, indicated on FIG. 1D serves to compensate and blend in with 53 the burn log cavity 44 applied wall thickness. Indications after installment of the 2×4 wood cross section 34 furnier panel 115 is inserted ( 5/16″ thick) with attached handle 39 on FIG. 1E securely to conform to 28 pattern. The handle 39 is used for up and pulling purposes. Spring hinged 42 in two places on configured 1/16″ thick metal 41 with red translucent plastic material to cover cutouts in relaying to illute in defining ash-drop clow, panel to be mounted to bottom surface of the attached cross section 34 positioned fairly flush with exterior surface 44. Tight rotating aluminum hinges 45 running from top to bottom inside the enclosure of the wall of burn log cavity 44 in four places, using suitable size not to exceed ¼″ long wood screws as required. Constituting the burn log cavity assembly 44 utilizing ¼″× 1/32″ thick steel stripes countersunk for #6,¼″ long ft. hd. Wood screws running from top to bottom as required in two places. Fasten on using appropriate glue or equivalent for ½″ wide ⅛″ thick foam rubber gray gasket 47 all around surface, of burn log cavity enclosure 44 ensuring tight light proof seam when depressed by its own total weight 44. Proper position spring steel 55 of suitable size and fasten sufficiently to serve as a lock for each steel strip 46 reinforced aluminum-hinged wings, left and right, when folding inward. In the folding process, attach handle centrally 51 and securely to mid-section of the three-sectional lock hinged top cover 49 of FIG. 1G. In reference to handles 51 and 39, they should be in accord to conform in adding authentication of the fireplace and large enough for required maneuverability to ensure its purpose. All knobs should follow suit.

Use black or dark gray rubberized paint on all of the bottom surfaces 48 and 49, left and right, with paint build up not to exceed 1/64″ thick. Attach ¾″×½″×2½″ long, hard wood blocks 56 in FIG. 10 with two countersunk holes on each block, to bottom surfaces sections 48, left and right, positioned appropriately to ensure the following functions in the unfolding process: lifting the assembled top cover 49 with pertaining hinged side sections 48 upward 90° from parallel outer surface of the burn log cavity 44 in FIG 1D into a horizontal mode which will wedge the attached hard wood blocks 56 attached on bottom surface of top cover side sections 48, left and right, to exert sufficient outwards pressure against the inner wall 44. Then pushed rear in a horizontal mode into the accommodating slotted recess 94 in FIG. 1A. Henceforth holding the assembled burn log cavity enclosure 44 seen in FIG. 1D, firmly and securely in place.

Attach ¼″ plywood of suitable size 59 of FIG. 1D with 5/16″ thick furnier 28 to 59 using a suitable bonding substance as required to achieve 53. Use 53 composite in five places around the burn log cavity opening 44 for utilizing 1/16″ thick ½″×½″×2″ long steel angle bracket 57 with two 6 mounting holes, twice per bracket and attach ¼″ thick plywood 59 to plywood wall 44 for utilizing #6, ¼″ long wood screws as required for attaching 53 in FIG. 1D to assure wall thickness appearance of burn log cavity opening 44 in FIG. 1D.

In referenced perspective, the three-sectional top cover for the burn log cavity 44 of which section 49 and side sections 48 are joined by lock hinge 50 on a 45° angle in assuring a more sufficient light blockage when erection process is completed. All sections are to be a 1″ thick appropriate wood and to have a 1/16″ Formica 59 piece in desired pattern covering the entire top surface. Two triangular obstructions 68 of suitable size are fitted to ensure the following condition as seen in FIG. 1A and FIG. 7: of an appropriate light weight material to run parallel and positioned between vertical slides 24 which incorporated and indented in the molded process, and are not to interfere or hinder the expected qualifications in assuring the necessary slides 24 function and serve purposefully in blocking slides 24 from view when fully erected.

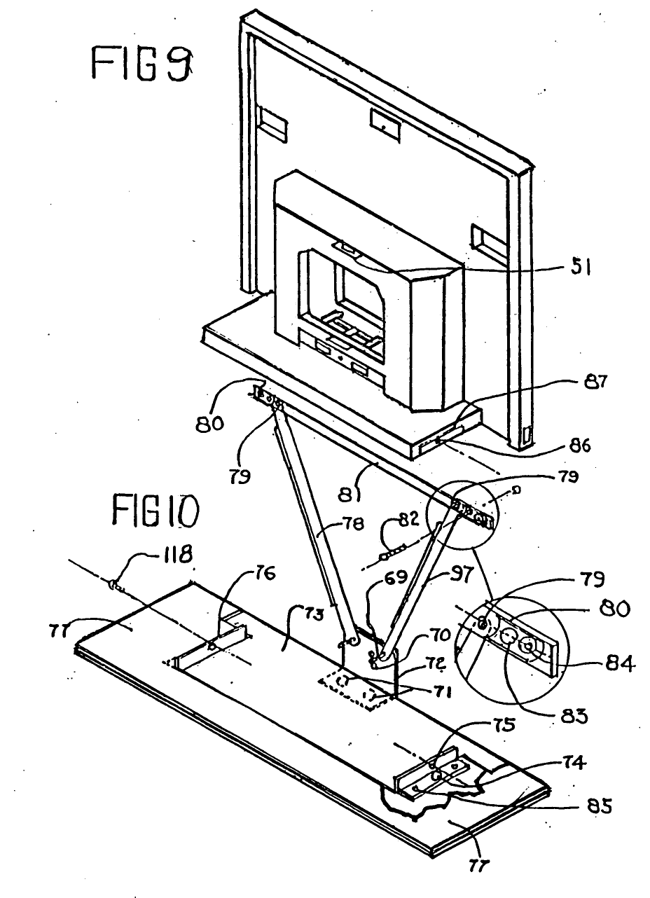

58 of FIG. 1A indicating an appropriate size recess closed in rear extending not to exceed beyond the extension level of the three sectional 67 and 65. left and right, outer perimeter of the backing wall of the fireplace thus adding the perception of depth in the burn log cavity in the molding process. The fully erected fireplace shown in FIG. 9 is placed in the accommodating base with its components shown in FIG. 10 a necessary accessory mainly supported on an angle of 90° floor to wall on a leverage principle, held secure in place by the accommodating base 77 with contributing factions seen in FIG. 10 as defined. Comprised of two #6 screws ¾″ to 1″ long, and 2 wood screws 82, penetrating components female lock channel 80 and 81 to secure to the room wall via the clearance hole 83, left and right, with the stationary rivet 84 connecting the female lock channel of sufficient length 80 and the ⅛″ thick×1 1/4″ wide aluminum strip 81 in appropriate male channel of suitable and required length 62 in FIG. 4 to interlock with the female lock channel 80 mounted on the pre-designated guide which originates from the accommodating base 77 as shown in FIG. 10. Utilize an appropriate rotating rivet 79 attaching the aluminum 1/16″ thick×¾″ wide strip 78 with angled stiffing edge-and an aluminum strip ¾″ wide× 1/16″ thick 97 to aluminum strip ⅛″ thick×1¼″ wide 81 of FIG. 10. Attach aluminum strips with stiffening angle 79 and 97, left and right, with clearance mounting holes utilizing threaded bolts 69 extruding from angle bracket 72 and tighten with appropriate wing nuts 70, left and right, as defined in FIG. 10. The predesignated positioning guide comprised of components as defined in FIG. 10, extrude from the accommodating base 77 to be attached to the room wall, reference to 82 wood screws. Henceforth position and secure the female lock channels 80, left and right, #6×1″ long corresponding with the backing wall attached male lock channels 62, left and right, when installed and locked in place. Maintain a recommended suspended distance of ⅜″ between the outer perimeter rear surface of the three-sectional hinged backing wall of the fireplace and the room wall so that the very extended guided and limited by ⅜″ diameter hard wood dowels 63 in FIG. 4 extruding positioned in three places with one positioned on top centrally and two positioned 10″ from bottom left and right on the very rear surface positioned centered ¾″ from outer edge perimeter all around providing a suitable space for ½″ diameter foam rubber gasket 61, gray positioned on the most outer extreme rear surface on the three-sectional backing wall of the fireplace centered ¼″ from the outer edge of the backing wall of the fireplace as defined in FIG. 4.

The gasket 61 in FIG. 4 is to be fused in position curtailed or incorporated in the molding process. So when suppressed ⅛″ to the limit dictated by the allowance of the ⅜″ diameter extruding ⅜″ dowels 69 in FIG. 4, and locked utilizing the attached lock channels 80 and 62, left and right, to conform with ⅜″ extruding extension of the dowels 63 will provide an appearance of a cement filling surrounding the attached backing wall of the fireplace.

The ⅜″ provided suspension serves to compensate for irregularities or curvatures which exist on all walls, for stabilizing and securing capability purpose attachment between the erected fireplace base and the accommodating base 77 with its components as indicated in FIG. 10 is accomplished as curtailed by utilizing bracket 76 5/16:×⅜″ angle 90°, 1/16″ thick steel mounted in two places left and right on a recess of suitable depth. To meet with the required thickness 76 in order to be flush with the component ¼″ plywood surface 73 utilizing two food hd. #6, ¼″ long wood screws 85 in two places left and right for mounting destined to hold and stabilize securely in place utilizing two 4-40×¼″ long ft. hd. self contained set screws 75, left and right, penetrating horizontally into the fireplace base and conforming with 4-40 threaded insert ¼″ deep 86, indented into the molding process 87 of FIG. 9 a recess 1/16″ deep of suitable size in respect to the bracket 76 of FIG. 1A dignent of a 90° angle bracket with ⅜″ mounting surface appropriately positioned running vertically parallel with the steel edge support wing 46 of the fire log cavity enclosure FIG. 3 with 5/16″ extrusion serving as a megnatic stop catch for steel supported edge 46 hinged wing, of the fire log cavity enclosure using suggested countersunk mounting holes, left and right as required for utilizing proper mounting screws on both brackets 46 to be indented so top surfaces are kept hidden from view in the molding process.

In referencing function of the pre-designated aluminum 1/16″ thick width in respect to 81 depicted in FIG. 10 with stiffening edge position guide arm 78 of FIG. 10, attached to the aluminum cross bar ⅛″ thick 81 utilizing a rotating rivet 79 in the condensing process when rotating 78 counter clockwise after it has been detached from the wing nut 70 which was fastened to a bracket 72 on the accommodating base FIG. 10 until stopped by 81 to line up parallel. In performing the secondary process of the pre-designated 1/16″ thick aluminum, with stiffening edge positioning guide 97 of attaching to 81 utilizing the rotation rivet 79 with shim spacer washer 98, 3/32″ thick steel situated as indicated in FIG. 10 to clear rotation path obstruction of the stationary rivet 84 utilization connecting the female lock channel 80 with the cross bar 81 for 94 when rotating counter clockwise after detached from wing nut 70 attached to the angle bracket 72 of the accommodating base defined in FIG. 10 until stopped by 81 to line up parallel. A slotted cutout of appropriate size 103 positioned centrally on 44 as defined in FIG. 3 to ensure the required clearance necessary to accommodate the horizontal slide action 43 in the folding and unfolding process. The 1/16″ thick aluminum 90° angled blocking bracket 102 of FIG. 3 curtailing suitable size countersunk mounting holes in two places attached centrally suitably positioned and mounted to bottom surface of the three-sectional hinged top cover of the burn log cavity enclosure 44 conforming with the necessary requirement for purposeful assurance intended in blocking the slotted cutout 103 from vision and detection of omitted light originating from the artificial burn log unit 96.

In reference to disclosing the behavior pattern of which the pertaining blocking bracket extension 102 will clear obstruction through opening of the burn log cavity enclosure 44 when positioned parallel in the folding and unfolding process as explained.

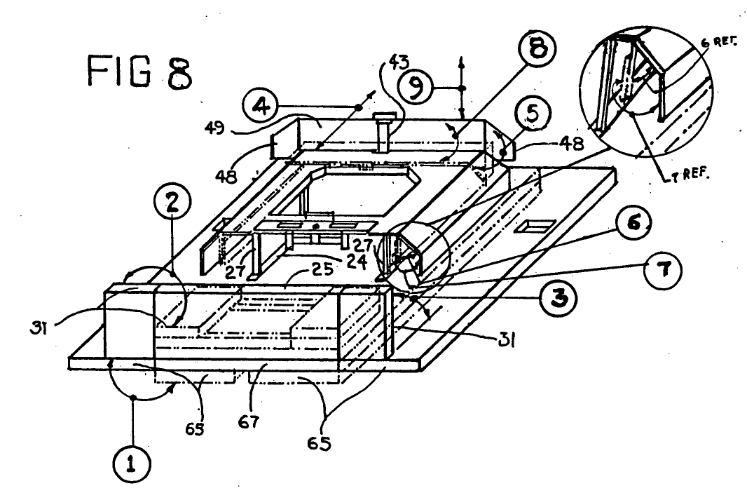

The following relates to providing the essential accessibility at an interval in the numbered sequences in the folding process FIG. 8 that is required and necessary in assuring its performance as claimed and curtailed.

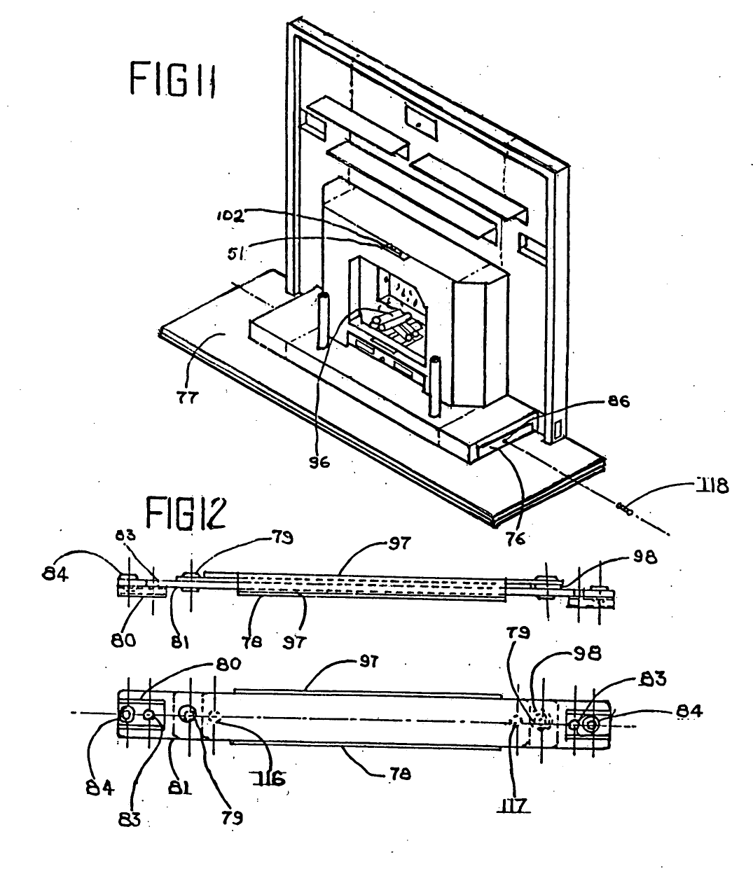

Lower right positioned in a rear perspective are two lead conductor wires, coded red 105 in FIG. 3 extending 12″ from its origin, the burn log unit 96 as indicated specifically in FIG. 11 connecting to female plug, coded red 110 situated from lower left front perspective as seen in FIG. 1A an upper left positioned rear perspective two lead conductor wires, coded blue 106 extending 12″ from its origin, the audio simulator 113 in FIG. 3 to connect with upper right positioned front perspective female plug, coded blue 109 in FIG. 1A.

A lower left positioned rear perspective two lead conductor wires, coded green 107 extending 12″ from its origin contracted to the pilot light bulb 114 in FIG. 3 situated centrally between two mounting spring hinges 42 on bottom surface of the cross bar, coded green 34 in FIG. 3 to connect to lower right positioned front perspective female plug, coded green 108 in FIG. 1A.

Signified by 104 as indicated on an existing standard receding line cord mechanism unit as shown in FIG. 4 left and right.

The following relates to FIG. 8 referred to as mechanical dilemma and deals with folding and unfolding process that describes in essence, the relationship to be observed in its functional designed performance, from one extreme to the other extreme. Commencing from the referenced stand point curtailed from the indicated by phantom line work which relates to FIG. 7 depicting the folded state to the other extreme an unfolded state indicated by solid line work as relayed in FIG. 9 utilizing encircled number defining sequences and directions to be observed in achievement of its functional requirement defined.

This pertaining composite related to FIG. 8 in elaborating reference to “encircled numbers” in sequence, which are described from a folded status into an unfolded status, which is as follows here:

Encircled Number 1 indicates the first mechanical movement left and right commencing a span travel of 180° of 65, left and right, defined by heavy line work of pertaining sections in FIG. 1A. Followed by:

Encircled Number 2 indicates the second mechanical movement left and right when unfolding of FIG. 1B with a 180° span travel of attached 31, left and right defined by heavy line work. Followed by:

Encircled Number 3 indicates the third mechanical movement of the attached fireplace base shown in FIG. 1B with a span travel of 90° locked in place on to FIG. 1A utilizing four extruding bolts 30 and fastened by self-contained wing nuts 38. Followed by:

Encircled Number 4 indicating the forth mechanical down movement of the enclosure 44 attached to vertical slides 24 to rest with sufficient forced contributed by its own weight on fireplace base.

Encircled Number 5 indicates the fifth mechanical movement curtailing a 90° span travel of 49 left and right, of the top cover referenced in FIG. 1G and defined by heavy line work seen in FIG. 8. Followed by:

Encircled Number 6 indicates the sixth mechanical movement of the aluminum hinged 45 winds of the enclosure 44 provides allowance for encircled number 7, indicating the seventh activated mechanical movement with a steel edge 46, left and right, enforced contracting with the magnetized vertical obtruding brackets 89, left and right henceforth held in place. Followed by:

Encircled Number 8 indicating the eighth mechanical movement, utilizing handle 51 referenced in FIG. 1A when lifting up the parallel with ourter surface of enclosure 44 top cover 90° to be horizontally positioned forces the bottom of the top cover mounted to 31, left and right hard wood block 56, left and right to wedge in when top cover attached to horizontal slide 43 is pushed backward into provided slotted cutout 94 on FIG. 1A as indicated by mechanical movement encircled Number 9. In the folding process, the reverse should also be applied sequentially.

It is essential to observe the necessary interval between sequence Number 4 and Number 5 for accessibility in order to connect the matching color coded male plugs originating from FIG. 3 to connect with the color coded female plugs situated on FIG. 1A.

Based on a suggestion of a decorative nature by fabricating interior and covered area of the enclosure 44 utilizing a suitably desired flat color to achieve distinction from the exterior.

Referring 116 indicates a clearance hole situated on 97 for ¼-20 bolt 69 extruding from 72 defined in FIG. 10 for tightening purposes by wing nut 70. A clearance hole situated on 78 for a ¼-20 bolt 69 extruding from 72 defined in FIG. 10 for tightening purposes by wing nut 70, 118 pertains to a 4-40 threaded ft. hd. X ¼″ long left and right penetrating horizontally.

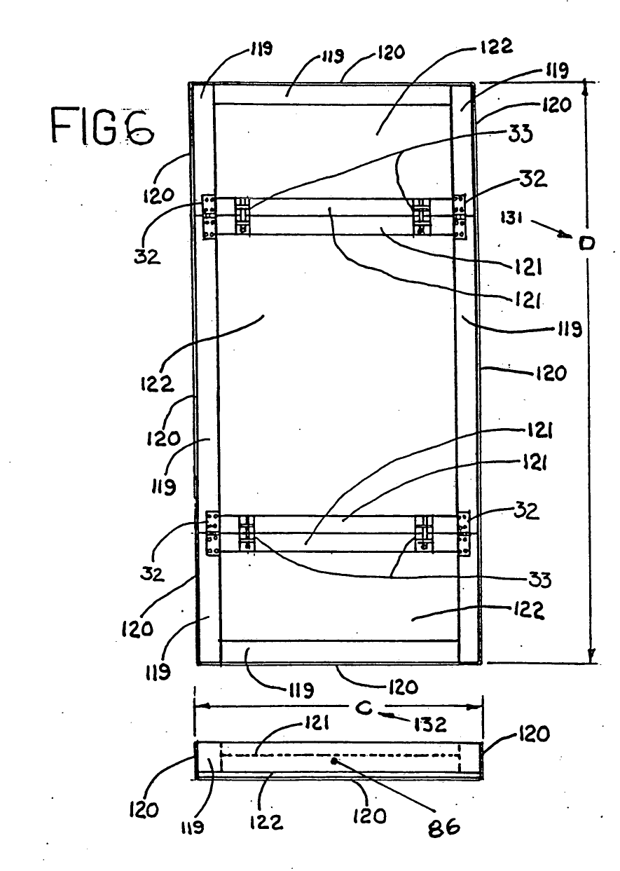

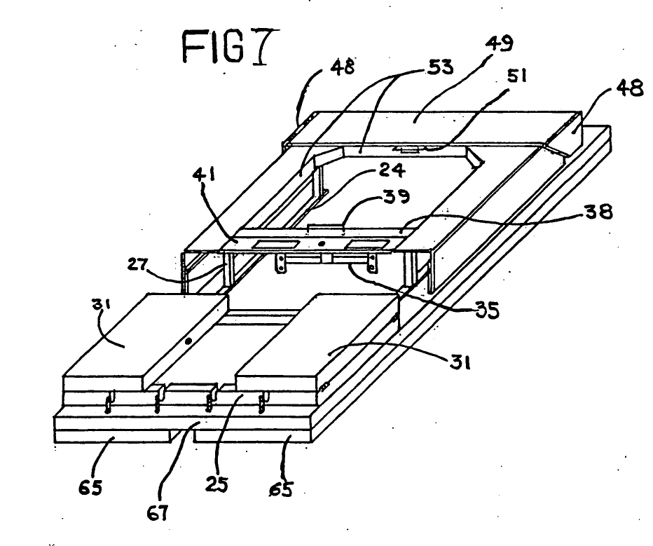

The following description particularly relates to the necessary molding process defined in FIG. 5 and FIG. 6. The molding composite is comprised of a lightweight strong and durable plastic serving the purpose essential for molding. Specifics are to conform to the depicted standard material defined to ensure its function and performance. Further specifics resort to provide for further required when molding provide for other pertaining specifics in the pertaining information as professed.

119 depicts a standard 2 by 4 (wood) taken into account of which the mold specifics are to conform to. 120 depicts a 1/16″ thick Formica taken into account of which the mold specifics are to conform to 121 depicts a wooden 2 by 3 (wood) taken into account of which the mold specifics are to conform to. 122 depicts fireplace base ½″ thick plywood taken into account of which the mold specifics conform to. 123 depicts ¼″ thick plywood into account of which the mold specifics are to conform to. 124 depicts a 5/16″ thick furnier taken into account of which the mold specifics are to conform to. 125 depicts backing wall ½ thick plywood taken into account of which the mold specifics are to conform to. 126 depicts the provision for receding line cord mechanism accommodation. 127 depicts the provision for open/close slide, flush with the surface left and right for the receding line cord opening.

128 cutout thru 6½″×4recessed to hold the control panel mount. 93 bolt lock recessed to be flush no obstruction positioned as shown in four places. 92 lock hinge recessed to be flush no obstruction positioned as shown in six places. 63 depicts ⅜″ diameter hard wood or equivalent dowel to extrude ⅜″ from originating surface situated on its center ¾″ from the outer edge in three places positioned on top centrally and 10″from bottom, left and right. As shown in pertaining FIG. 5 male lock channel 62, left and right, positioned as shown to pinpoint accuracy with the female lock channel 80, left and right to lock in place contributed by pre-designated positioning guide as shown in FIG. 10 depicted by 61, is a ½″ diameter gray color foam rubber gasket to be situated and fastened stationary on simi-circumferenced positioned flush with outer edge shown in FIG. 5. Provide for the attachment of locking hinge 32 recessed to be flush with the surface with no obstruction positioned in four places as shown in FIG. 6. Provide for a sophisticated lock bolt 33 attachment mount recessed, with no obstruction, positioned in four places as shown in FIG. 6 provide for 89 incorporated far side vertically running magnetized stop angle bracket, left and right. Install vertical slides 24 on far side appropriately positioned serving to attach 27-construction bar assembly. Position and incorporate slide blockers 68, on far side, left and right appropriately positioned serving to obstruct slides from view 30 on far side extending stationary threaded ½″ diameter bolts in four places for wing nut tightening.

132 is to be observed as an 18″ distance. In order not to divert from the proportional shape curtailed which provides a credible depth to credit it's performance. To be followed suit by 131 of 60″ distance, 129 of 66″ distance and 130 of 75″ distance.

### BACKGROUND OF THE INVENTION

The Artificial Portable Fireplace is a fireplace of virtual reality. The development process, from the time of its origination perpetuated and progressed over a period of years, and only recently entered into a satisfactory status of completion in design and documentation for manufacturing.

An artificial fireplace is certainly nothing new, but the folding capabilities contributed by its mechanical characteristics is an attribute in serving as an obvious asset and contributes in resulting as a definite advantage over any alternative which invoke excessive labor cost, clean up, and present problems of major proportion especially to landlords for fear of excessive damage resulting in rejection. This fireplace would satisfy the conceived adaptation of a desired need on a quantitative basis for apartments, which at present are deprived of.

The Artificial Portable Fireplace has the capability to fold and unfold, is easy to install and remove, repetitiously if desired, and assures no more damage to the wall than hanging a picture frame. It can be transported anywhere at will and serves to add charm and enchantment resulting in a more appealing and pleasant surrounding. It is designed to be suitable for regular size rooms, as well as conspicuously prominent and outstanding for larger areas. It is beneficial and practical, appropriate for all types of apartments, offices, possibly even motels, etc., and certainly favorable in warmer climates, for obvious reasons, can be easily removed and stored.

The Artificial Portable Fireplace rivals practically all the exquisite features in realism, and is virtually impossible to distinguish from the real thing. It is capable of functioning on a 110 V.A.C. or 220 V.A.C. line voltage and is adaptable through receding line cords (left and right) for convenience.

### SUMMARY OF THE INVENTION

The Artificial Portable Fireplace is a one unit product, (with accessible accommodating base for mounting installation), capable of converting from a folded state to full size fireplace. At one extreme (fully folded), the product is comparable to a large suitcase in size, with approximate weight of 65 lbs. (possibly much less) and containable within a 3¼foot×5½foot×1¾foot area for easy packaging, transporting and storage purposes. At its other extreme (fully unfolded), represents is a full size fireplace measuring 6¼foot×5½foot×1¾foot by simple described mechanical movements sequentially activated to accomplish this transformation from one extreme to the other.

The unit's special effects requirements are channeled through the control panel (with an open/close cover) which is strategically situated and easily accessible, but out of reach and safe from children. The control panel contains five individual functional controls (with one optional arrangement of a heat reflector, if so desired), which are described as follows:

1—(3) Position Audio Variation Control

2—Variable Log Flame Intensity Control

3—Variable Intensity Control (of ash-drop glow)

4—Voltage Selector Switch (110 V.A.C./220 V.A.C.) and On/Off switch

5—Push Button Line Fuse (with Automatic Reset)

Optional arrangement for heat reflector control. Further possible, obtions on demand in addition to this concept, such as installation of shelving arrangement (for books, etc.)

With various other options, including traditional extruding vertical side poles (left and right) from the fireplace base, depicting a rendition of classics, can be implemented to follow suit.

All this complies with the expectation of this newly developed product of a pre-fabricated origin), characterized with unique mechanical attributes to ensure requirements in functioning to perform in realism.

This commercial product is in its entirety a tribute through achievement in self origination, not reproduced, copied, or duplicated, from any existing product, in any or all its facets. Anything to the contrary, is purely unfounded and without prior knowledge and/or awareness, of the originator.

As a basic concept, this one unit product, with the accessible accommodating base will perform as described.

### DETAILED DESCRIPTION OF DRAWINGS

FIG. 1A—Front view (in an isometric perspective) of an assembled section, in an exploded mode of the three section hinged fireplace-backing wall.
B—Top view (in an isometric perspective) of the fireplace folding base, in an exploded mode in respect to FIG. 1A
C—Top view (in an isometric perspective) of the rack, which supports the electrically energized artificial burn log unit in an exploded mode, in respect to FIG. 1D
D—Front view (in an isometric perspective) of the flame houseing cavity, in an exploded mode, in respect to FIG. 1A
E—Front view (in an isometric perspective) of an insert panel (with handle) in an exploded mode, in respect to FIG. 1D
F—Front view (in an isometric perspective) of the ash-drop glow enclosure panel, in an exploded mode, in respect to FIG. 1D
G—Top view (in an isometric perspective) of the receding and extending (three sectional hinged) folding top cover, in an exploded mode, in respect to FIG. 1D
H—Bottom view (in an isometric perspective) of the rittal construction bars assembly, which connect FIG. 1A to FIG. 1D, in an exploded mode.

FIG. 2—Bottom view (in an isometric perspective) of the fireplace folding base.

FIG. 3—Rear view (in an isometric perspective) of FIG. 1D (flame housing cavity) with attached FIG. 1C (rack of artificial log support)

FIG. 4—Rear view, of FIG 1D (in an isometric perspective) of the three sectional hinged backing wall of the fireplace

FIG. 5—Rear view and side view (in an orthographic projection perspective) of FIG. 1A (fireplace backing wall) indication conformance equivalent for mold construction

FIG. 6—Rear view and side view (in an orthographic projection perspective) of FIG. 1B (fireplace folding base) indicating conformance equivalent for mold construction

FIG. 7—Shoes (in an oblique perspective) the one unit product folded to one extreme

FIG. 8—Shows (in an oblique perspective) the mechanical dilemma from one extreme, sequentially

FIG. 9—Shows (in an isometric perspective) of an erected one-unit fire place, when fully extended to one extreme

FIG. 10—Shows (in an isometric perspective) the accommodating base, in respect to FIG. 9 (the erected fireplace)

FIG. 11—Shows (in an isometric perspective) a fully erected fireplace, with optional accessories such as: shelving and randitional classic side poles attachment (left and right)

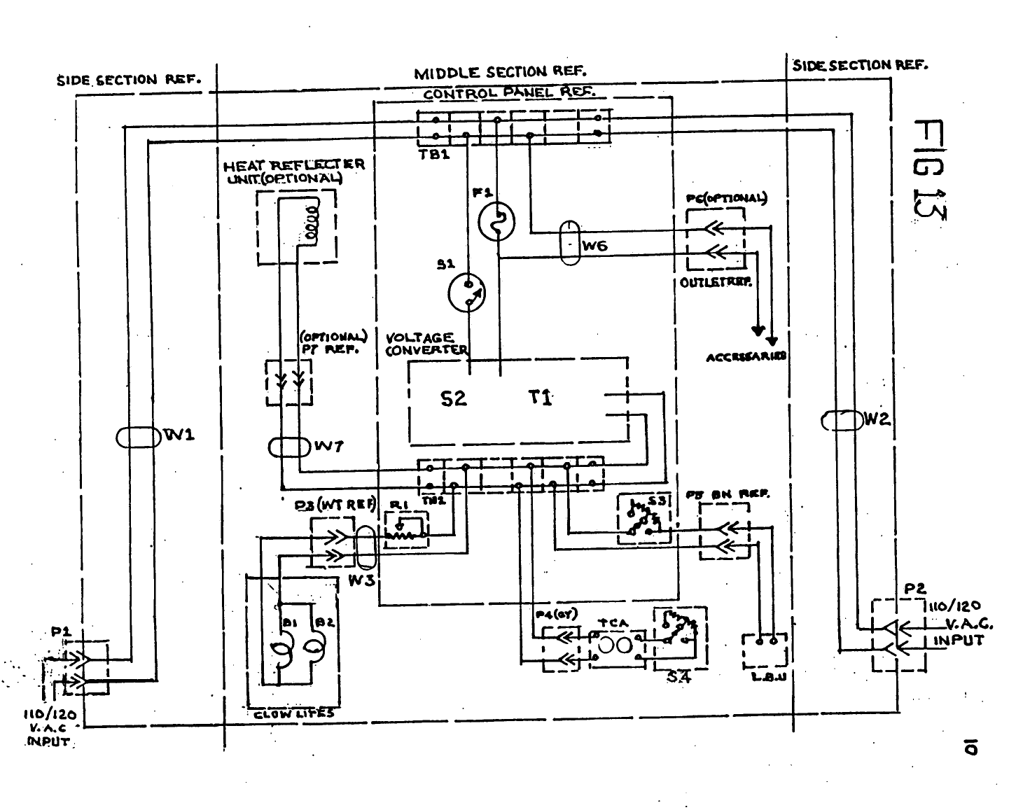

FIG. 12—Top and side view (in an orthographic perspective) of a wing nut attachable and detachable, predesignated positioning guide for condensing and storage purpose in reference to FIG. 10

FIG. 13—Electrical circuity essential to its performance

I claim:

1. The artificial portable fireplace (indoor recommended) is inherent a one unit product, encombed to a electrically energized operating capacity, facilitated as an installment enhancement capability, by rendering itself instrumental in the essential utilization of (9) predesignate individual mechanical activated segments in sequence, to achieve with assurance, in fulfilling its purpose of converting, from one extreme, comparable to a large suitcase (when folded) into the other extreme, constituting an erected full size fireplace, inherently versatile in accommodating small areas, and prominently conspicuous, for large areas, comprised of various components, one of a foremost light weight, strong and durable, formulated plastic mold, which is affiliated for the folding process, by utilization of spring hinges attached to the fireplace base, a plastic molded three sectional lock hinged backing wall of the fireplace of which is applied, the use of a 180 degree limited hinge span allowance, and sophisticated pertaining bolt locks, for stabilization and securing purposes, and only equated by a three sectional lock hinged fireplace base molded and characteristically following suit, by the required use of a 180 degree limited hinge span allowance, assessing the essential and necessary element in it's function, the connection epic between the burn log unit cavity enclosure, faciliated with the two vertical slides stationary and securely attached and situated, on the three sectional, front surface on the backing wall of the fireplace, will be instrumental in the use of the up and down slide action movement involving the utilization of the construction bars assembly, to achieve securing permanent stability, When the unfolded fireplace is placed, and attached to the fasciliated accommodating base, than fastened securely in the manor relayed as follows: by a preferred utilization of the referred to, anchoring screws with the vertical decent penetration, the provisioned clearance holes on the accommodating base, left and right in addition the utilization of horizontal set screw penetrant left and right into provided threaded inserts on the fireplace base, left and right in the fireplace.

2. The artificial portable (indoor recommended) fireplace, as defined in claim 1, the prestigiously oriented and centrally mounted and positioned in a folded manner, with drum (closed part of hinge) facing forward, leaving attached hinge sandwiched between (the closed) one wing of hinge attached to the slide component of horizontal slide and remaining part of bottom surface of top cover, on burn log cavity enclosure, renders prestigiously attached in this fashion instrumental of being at liberty to rotate at 90 degrees (up or downward in the utiliztation of requirements) to accomplish it's designated requirements in the folding process.

3. The artificial portable (indoor recommended) fireplace, as defined in claim 1, comprises the predesignated positioning guides, characteristic in it's detachability and condensable purpose, utilizes essentsability to render in service the desired pinpoint positioning for lock channel attachments on a precalibrated basis, in the counterpart locking purpose.

4. The artificial portable (indoor recommended) fireplace, as defined in claim 1, utilization of a gray foam rubber gasket semi perahmetrically deployed, when surpressed will serve a definitive purpose in compensating for the partial suspension gap (between the wall and fireplace) prefaced to counter wall imperfection, (after installation) will be purposeful rendering to serve in the appearance, as a cement type filling approbriate in the fireplaces.

5. The artificial portable (indoor recommended) fireplace, as defined in claim 1, which is an attribute due the preceived proportional design contributing credibility appropriated manner in maintaining a measurement of approbriatly sufficient 8.5″ between the inner front surface of the burn log cavity enclosure (in the unfolded state) and the front surface of the backing wall of the fireplace with an added prefered 3″ recess extension to gain a desireable gain of a preferred distance, in obtaining suffient cubic space, in the burn log enclosure.

6. The artificial portable fireplace (indoor recommended) as defined in claim 1, is dependened in the stationary connection epic, is situated between the involved inner surface of the unfolded burn log cavity enclosure, and outer surface of the three sectional backing wall of the fireplace, encombed in the utilization of the accumulated (rittal) construction bars assembly, in a securely fastened adaption, in preparation to follow suit.

7. The artificial portable fireplace, (indoor recommended) as defined in claim 1, relates to installation technique and borders perspectively in utilizing purposeful credibility and definition aspect related in claim 1, attachment and mounting technique is pertinent in great part to a semi suspension state between the room wall, to compensate the imperfect surface for flawless adaption.

8. The artificial portable fireplace (indoor recommended) as defined in claim 1, and claimed size dimensions indicated in the molding process are as indicated to be maintained in the order to achieve the necessary proportional shape asurance in obtaining required depth perspective defined.
